(19) United States
(12) Patent Application Publication
(10) Pub. No.: US 2022/0315243 A1
(43) Pub. Date: Oct. 6, 2022

(54) METHOD FOR IDENTIFICATION AND RECOGNITION OF AIRCRAFT TAKE-OFF AND LANDING RUNWAY BASED ON PSPNET NETWORK

(71) Applicant: CHONGQING UNIVERSITY, Chongqing (CN)

(72) Inventors: Yongduan SONG, Chongqing (CN); Fang HU, Chongqing (CN); Ziqiang JIANG, Chongqing (CN)

(73) Assignee: CHONGQING UNIVERSITY, Chongqing (CN)

(21) Appl. No.: 17/327,182

(22) Filed: May 21, 2021

(30) Foreign Application Priority Data
Apr. 1, 2021 (CN) 202110353929.2

(51) Int. Cl. B64D 45/08; G06K 9/00; G06K 9/62; G06N 3/08

(52) U.S. Cl. CPC B64D 45/08; G06K 9/0063; G06K 9/6256; G06K 9/623; G06N 3/08

(57) ABSTRACT

The present disclosure relates to a method for identification and recognition of an aircraft take-off and landing runway based on a PSPNet network, wherein the method: adopts a residual network ResNet and a lightweight deep neural network MobileNetV2 as the two backbone feature-extraction networks to enhance that feature extraction; at the same time adjusts an original four-layered pyramid pooling module into five layered, with each layer being respectively sized by 9×9, 6×6, 3×3, 2×2, 1×1; uses a finite self-made image about the aircraft take-off and landing terrain for training; and labels and extracts the aircraft take-off and landing runway in the aircraft take-off and landing terrain image. The method effectively combines ResNet and MobileNetV2, and improves the detection accuracy of the aircraft take-off and landing runway in comparison with the prior art.

This patent application claims the benefit and priority of Chinese Patent Application No. 202110353929.2, filed on Apr. 1, 2021, the disclosure of which is incorporated by reference herein in its entirety as part of the present application.

### TECHNICAL FIELD

The present disclosure relates to the technical field of computer vision and pattern identification and recognition, in particular to a method for identification and recognition of an aircraft take-off and landing runway based on a PSPNet network.

### BACKGROUND ART

The semantic segmentation technique used in the identification and recognition of the aircraft take-off and landing terrain is a key technique in the computer vision field and pattern identification and recognition field, and also a core technique in the field of environmental perception. Semantic segmentation may be used to combine object detection and image classification to achieve the entire environmental perception. At present, the semantic segmentation technique is widely used in fields such as automatic unmanned driving, surface geological detection, facial segmentation, medical detection and recognition, and has increasingly attracted more and more attention in recent years. The semantic segmentation algorithm mainly consists of the semantic segmentation based on full convolution network (FCN) and the semantic segmentation based on context knowledge, wherein the semantic segmentation based on FCN is to adopt a cascade convolution layer and a pooling layer to continuously abstract features in an image so as to obtain a feature map, and finally to obtain a feature map restored to its original size through transposed convolution interpolation to complete the semantic segmentation of the image pixel by pixel. While the semantic segmentation based on context knowledge is to add the global information of image features into the CNN processing, and to input the image features as sequences to model the global context information and improve the semantic segmentation achievements.

With the continuous development and application of in-depth learning, a semantic segmentation network based on context knowledge works well in the terrain identification and recognition application. In comparison with traditional segmentation methods, the semantic segmentation network based on context knowledge has greatly improved segmentation accuracy and fineness. By virtue of a good segmentation effect, the semantic segmentation network based on context knowledge and some excellent neural networks are gradually applied in the terrain identification and recognition field. However, because neural networks in the prior art usually adopt a backbone network to extract features, the identification and recognition accuracy is not high.

### SUMMARY

For the problem described above for the prior art, a technical problem to be solved by the present disclosure is how the accuracy could be improved for the identification and recognition of the aircraft take-off and landing runway.

To solve the technical problem described above, the present disclosure adopts the following technical scheme: a method for identification and recognition of an aircraft take-off and landing runway based on a PSPNet network, including:

Step 100: building a PSPNet network, wherein according to an image processing flow, the PSPNet network includes the following parts in sequence:

Two feature-extraction backbone networks that are respectively used for extracting feature maps;

Two enhanced feature-extraction modules that are respectively used for further feature extraction of the feature maps extracted by the backbone feature-extraction networks;

An up-sampling module which is used for restore the resolution of an original image;

A size unification module that is used for unifying the sizes of the enhanced features extracted by the two enhanced feature-extraction modules;

A data serial connection module that is used for serially connecting two enhanced features processed by the size unification module;

A convolution output module that is used for convolution and output of the data processed by the data serial connection module;

Step 200: training the PSPNet network, which has the following training processes:

Step 210: building a training data set,

Wherein N pieces of optical remote sensing data images are collected, some of the images which meet a terrain specific to aircraft take-off and landing are selected for amplification, interception, and data set labeling, namely marking the position and the area size of the aircraft taking off and landing runway, wherein all labeled images are used as training samples which then constitute a training data set;

Step 220: initializing parameters in the PSPNet network;

Step 230: inputting all the training samples in the training set into the PSPNet network to train the PSPNet network;

Step 240: calculating a loss function, calculating a cross entropy between the prediction result obtained after the training samples are input into the PSPNet network and the training sample labels, i. e., the cross entropy between all pixel points in the prediction image that enclose the area of the aircraft take-off and landing runway and all pixel points in the training samples that label the aircraft take-off and landing runway; through repeated iterative training and automatic adjustment of the learning rate, obtaining an optimal network model when the loss function value stops dropping;

Step 300: detecting the image to be detected, inputting the image to be detected into the trained PSPNet network for prediction, filling the predicted pixel points in red, and outputting the prediction result, wherein the area surrounded by all pixel points filled in red is the runway area where the aircraft takes off and lands.

As an improvement, a residual network ResNet and a lightweight deep neural network MobileNetV2 are adopted for the two backbone feature-extraction networks;

By adopting the residual network ResNet and the lightweight deep neural network MobileNetV2, feature extraction is performed for the input image respectively to obtain two feature maps.

As an improvement, the two enhanced feature-extraction modules perform further feature extraction on the two feature maps, specifically including that the feature map obtained by the residual network ResNet are divided into regions sized by 2×2 and 1×1 for processing, and the feature map obtained by the lightweight deep neural network MobileNetV2 are divided into regions sized by 9×9, 6×6, and 3×3 for processing.

In comparison to the prior art, the present disclosure has at least the following advantages:

1. PSPNet in the present disclosure is a typical semantic segmentation network introducing context knowledge. Given the features that the aircraft take-off and landing runway is quite long during the identification and recognition of the aircraft take-off and landing terrain, the runway width varies along with the distances of collected remote sensing images, the gray level distribution is relatively uniform, the PSPNet semantic segmentation network may result in better segmentation and obtain good capability in scene identification and recognition.

2. According to the present disclosure, the neural network PSPNet in the prior art is improved, and two backbone networks, namely the residual network ResNet and the lightweight deep neural network MobileNetV2, are used for generating an initial feature map, fully combining the advantages of the two networks. ResNet may solve the problems of poor classification performance, slower convergence and reduced accuracy after the CNN network reaches a certain depth; and MobileNetV2 architecture is based on an Inverted Residual Structure, thereby removing the nonlinear transformation from the main branch of the residual structure and effectively maintaining the model expressiveness. The inverted residual is mainly used to increase the extraction of image features in order to improve the accuracy.

### BRIEF DESCRIPTION OF THE DRAWINGS

FIG. 1 is an example of a self-made data set image.

FIG. 2 is a diagram of data set labeling by using a labelme tool.

FIG. 3 is a flow chart of image preprocessing.

FIG. 4 is a diagram of image preprocessing results.

FIG. 5 is a structure diagram of a PSPNet network according to the present disclosure.

FIG. 6 shows a (ALL class) comparison of predicted performance indicators between the PSPNet network according to the present disclosure and a traditional PSPNet network.

FIG. 7 shows a (Runway class) comparison of predicted performance indicators between the PSPNet network according to the present disclosure and the traditional PSPNet network.

FIG. 8 shows a comparison of segmentation results between the PSPNet network according to the present disclosure and the traditional PSPNet network, in which (a) is a segmentation effect diagram of the traditional PSPNet and (b) is the segmentation effect diagram of the PSPNet according to the present disclosure.

### DETAILED DESCRIPTION OF THE EMBODIMENTS

The present disclosure will be further described with reference to accompanying figures below.

A method for identification and recognition of the aircraft take-off and landing runway based on the PSPNet network includes the following steps:

Step 100: building a PSPNet network, as shown in FIG. 5, wherein according to an image processing flow, the PSPNet network includes the following parts in sequence:

Two feature-extraction backbone networks that are respectively used for extracting feature maps; wherein a residual network ResNet and a lightweight deep neural network MobileNetV2 are adopted for the two backbone feature-extraction networks; and by adopting the residual network ResNet and the lightweight deep neural network MobileNetV2, feature extraction is performed for the input image respectively to obtain two feature maps.

Two enhanced feature-extraction modules that are respectively used for further feature extraction of the feature maps extracted by the backbone feature-extraction networks; wherein the two enhanced feature-extraction modules perform further feature extraction on the two feature maps, specifically including, that the feature map obtained by the residual network ResNet are divided into regions sized by 2×2 and 1×1 for processing, and the feature map obtained by the lightweight deep neural network MobileNetV2 are divided into regions sized by 9×9, 6×6, and 3×3 for processing.

Specifically, by assuming that a feature layer obtained by the backbone feature-extraction networks is 90×90×480, as for the 9×9 area, it is necessary to set the average pooling step size stride to 90/9=10 and the convolution kernel size kernel_size to 90/9=10; as for the 6×6 area, it is necessary to set the average pooling step size stride to 90/6=15 and the convolution kernel size kernel_size to 90/6=15; as for the 3×3 area, it is necessary to set the average pooling step size stride to 90/3=30 and the convolution kernel size kernel_size to 90/3=30; as for the 2×2 area, it is necessary to set the average pooling step size stride to 90/2=45 and the convolution kernel size kernel_size to 90/2=45; as for the 1×1 area, it is necessary to set the average pooling step size stride to 90/1=90 and the convolution kernel size kernel_size to 90/1=90. When it comes to the final convolution layer, the feature maps extracted by two backbone networks are used to replace a combination of the feature map extracted by one backbone network in the PSPNet network and the up-sampling result output by the pyramid pooling module of the PSPNet network, which are then used as the input of the convolution layer of the PSPNet network.

An up-sampling module which is used for restore the resolution of an original image.

A size unification module that is used for unifying the sizes of the enhanced features extracted by the two enhanced feature-extraction modules.

A data serial connection module that is used for serially connecting two enhanced features processed by the size unification module.

A convolution output module that is used for convolution and output of the data processed by the data serial connection module.

Step 200: training the PSPNet network, which has the following training processes:

Step 210: building a training data set,

Wherein N pieces of optical remote sensing data images are collected, sonic of the images which meet a terrain specific to aircraft take-off and landing are selected for amplification, interception, and data set labeling by a labelme tool, namely labeling the position and the area size of the aircraft taking off and landing runway, as shown in FIG. 2, wherein all labeled images are used as training samples which then constitute a training data set. The training samples are images labeled with the position and area size of the runway where the aircraft takes off and lands.

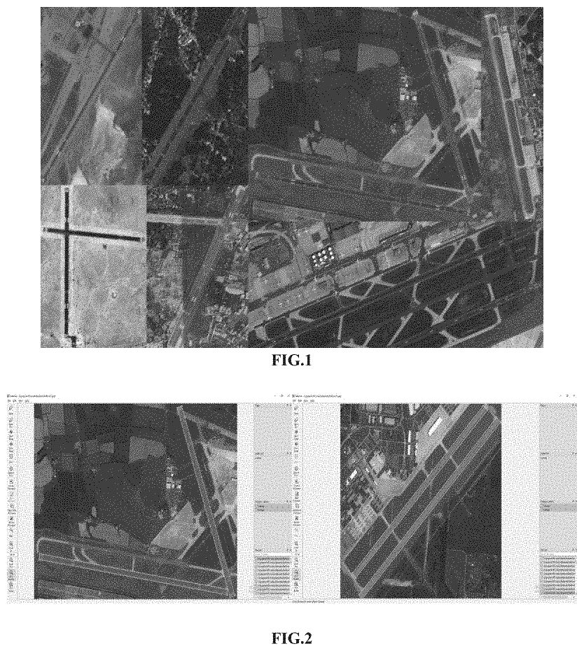

The N pieces of optical remote sensing data images adopt DIOR, NUSWIDE, DOTA, RSOD, NWPU VHR-10, SIRI-WHU and other optical remote sensing data sets as basic data sets, including various terrain areas such as airport runways, building constructions, grasslands, fields, mountains, sandy areas, muddy areas, cement areas, jungles, sea, highways, and roads, as shown in FIG. 1.

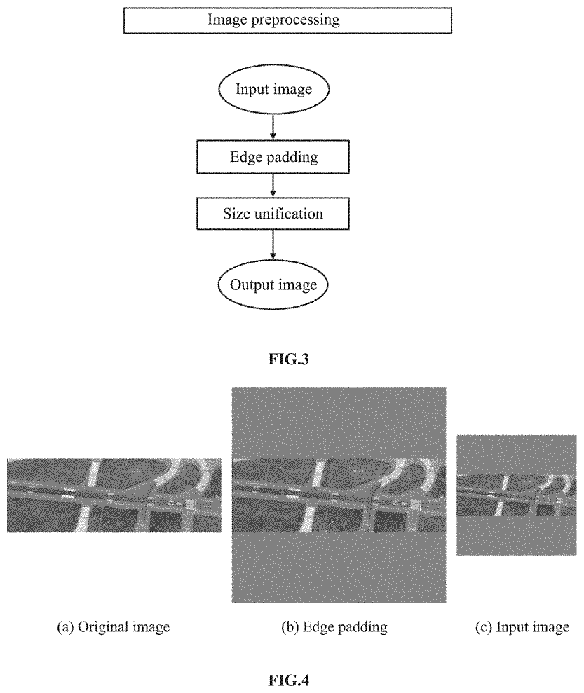

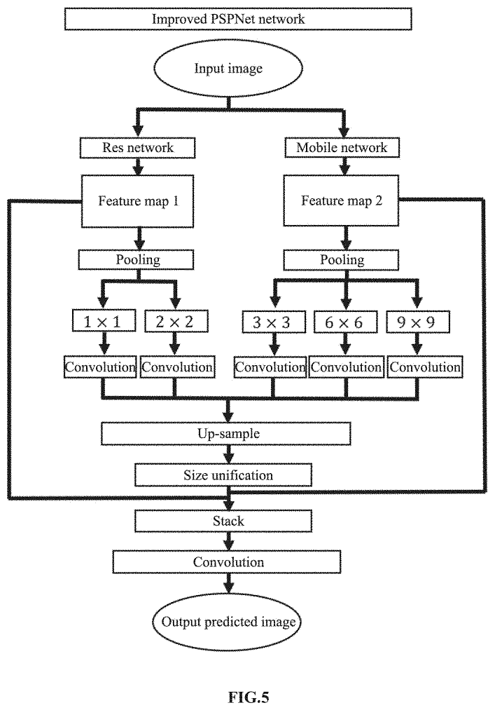

In order to prevent image distortion during the image zooming which affects the accuracy and precision of the network, preprocessing is necessary for the images, including image edge padding, so as to achieve an aspect ratio of 1:1 which meets the requirement of network input. At the same time, geometric adjustment is performed for the image sizes to meet the optimal size of network input. The picture preprocessing flow is as shown in FIG. 3, and the result of picture preprocessing is as shown in FIG. 4.

Step 220: initializing parameters in the PSPNet network;

Step 230: inputting all the training samples in the training set into the PSPNet network to train the PSPNet network;

Step 240: calculating a loss function, calculating a cross entropy between the prediction result obtained after the training samples are input into the PSPNet network and the training sample labels, i. e., the cross entropy between all pixel points in the prediction image that enclose the area of the aircraft take-off and landing runway and all pixel points in the training samples that label the aircraft take-off and landing runway; through repeated iterative training and automatic adjustment of the learning rate, obtaining an optimal network model when the loss function value stops dropping;

Step 300: detecting the image to be detected, inputting the image to be detected into the trained PSPNet network for prediction, filling the predicted pixel points in red, and outputting the prediction result, wherein the area surrounded by all pixel points filled in red is the runway area where the aircraft takes off and lands.

In order to effectively utilize computing resources of mobile devices and embedded devices, and to improve the speed of real-time processing of high-resolution images, MobileNet is introduced in the present disclosure. In the present disclosure, in view of that the MobileNetV2 parameters, which reduces the consumption of computing resources by 8-9 times compared with ordinary FCN, is relatively less in quantity and fast in computing speed, MobileNetV2 is selected as a backbone feature-extraction network in PSPNet. However, the lightweight MobileNetV2 will inevitably reduce the segmentation accuracy of PSPNet slightly. Therefore, ResNet is reserved as another backbone feature-extraction network in PSPNet, which has good performance in network classification and has high accuracy, thus improving the segmentation accuracy in the PSP module. ResNet and MobileNetV2 work together so as to improve the operation speed of PSPNet on one hand, and to improve the segmentation accuracy as possible on the other hand, meeting the requirements of low consumption, real-time performance and high precision of segmentation tasks.

### EXPERIMENTAL VERIFICATION

The present disclosure adopts Mean Intersection over Union (MIoU), Pixel Accuracy (PA) and Recall as evaluation indicators to measure the performance of the semantic segmentation network. First of all, we calculate MIoU, PA and Recall through the confusion matrix as shown in Table 1.

TABLE 1
Confusion Matrix

| | | Predicted Value | |
|---|---|---|---|
| Confusion Matrix | | Positive | Negative |
| True Value | Positive | True Positive (TP) | False Negative (FN) |
| | Negative | False Positive (FP) | True Negative (TN) |

### (1) Mean Intersection Over Union (MIoU)

MIoU is a standard measure of the semantic segmentation network. In order to calculate MioU, it is necessary to calculate the intersection over union (IoU) of each class object for the semantic segmentation, that is, a value of the intersection-to-union ratio of a ground truth value and a predicted value of each class. The IoU formula is as follows:

$$IoU = \frac{TP}{TP + FP + FN}$$

MIoU refers to an average of IOUs of all classes across the semantic segmentation network. Assuming that there are k+1 class objects (0,1 . . . ,k) in the data set, and class 0 usually represents the background, so we have the MIoU formula as follows:

$$MIoU = \frac{1}{k + 1} {\sum }_{i = 0}^{k} \frac{TP}{TP + FP + FN}$$

### (2) Pixel Accuracy (PA)

PA is a measurement unit of the semantic segmentation network, which refers to the percentage of correctly labeled pixels in total pixels. The PA formula is as follows:

$$PA = \frac{TP + TN}{TP + TN + FP + FN}$$

### (3) Recall

Recall is a measurement unit of the semantic segmentation network, which refers to the proportion of samples with the predicted value and ground truth value both of 1 in all samples with the ground truth value of 1. The Recall formula is as follows:

$$Recall = \frac{TP}{TP + FN}$$

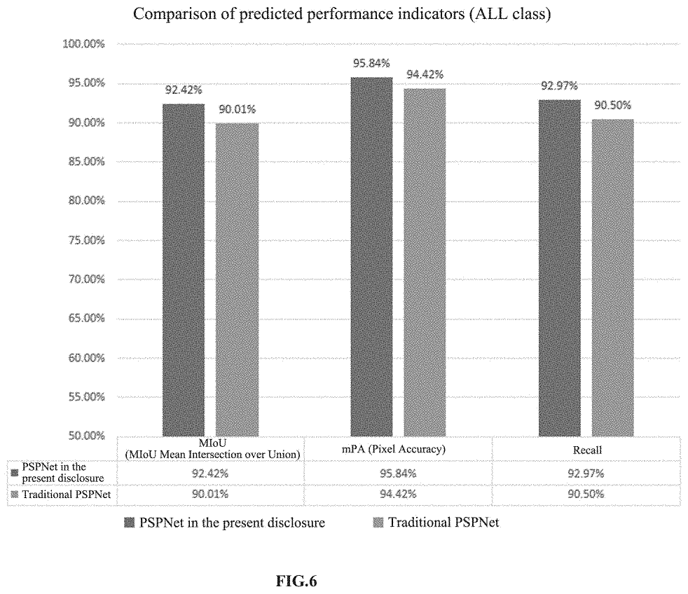

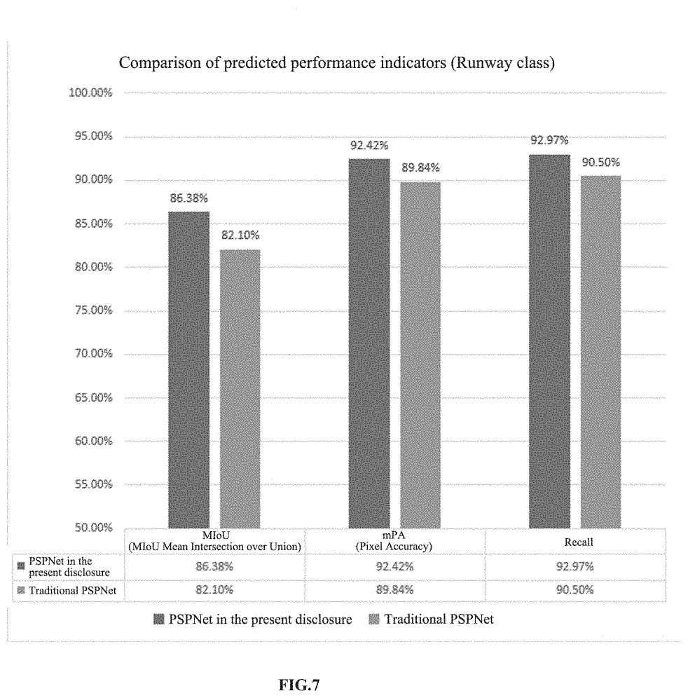

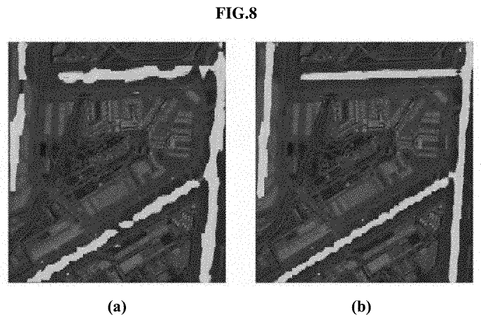

According to the present disclosure, a self-made test set is adopted to test the trained PSPNet semantic segmentation network, and the prediction results are shown in FIG. 6 and FIG. 7. It can be seen that whether it is ALL class or Runway class, the PSPNet semantic segmentation network utilizing the embodiment of the present disclosure shows three performance indicator values of Mean intersection over Union (MIoU), Pixel Accuracy (PA) and Recall higher than those obtained in traditional PSPNet training, indicating that the improved network is improved to a certain degree in performance in comparison with the traditional PSPNet. The data set is divided in the case of the same training and testing data and the same training parameters, and the segmentation effect of the neural network used in the method herein is compared with that of the traditional PSPNet for analysis. The segmentation results obtained by the two methods are as shown in FIG. 8, in which it can be seen that for the PSPNet neural network utilizing the embodiment of the present disclosure, the target area is segmented more effectively.

Finally, it is noted that the above embodiments are only for the purpose of illustrating the technical scheme of the present disclosure without limiting it. Although a detailed specification is given for the present disclosure by reference to preferred embodiments, those of ordinary skills in the art should understand that the technical schemes of the present disclosure can be modified or equivalently replaced without departing from the purpose and scope of the technical schemes thereof, which should be included in the scope of claims of the present disclosure.

1. A method for identification and recognition of an aircraft take-off and landing runway based on a PSPNet network, comprising:
building a PSPNet network, wherein according to an image processing flow, the PSPNet network includes the following parts in sequence:
two feature-extraction backbone networks that are respectively used for extracting feature maps;
two enhanced feature-extraction modules that are respectively used for further feature extraction of the feature maps extracted by the backbone feature-extraction networks;
an up-sampling module which is used for restore the resolution of an original image;
a size unification module that is used for unifying the sizes of the enhanced features extracted by the two enhanced feature-extraction modules;
a data serial connection module that is used for serially connecting two enhanced features processed by the size unification module; and
a convolution output module that is used for convolution and output of the data processed by the data serial connection module;
training the PSPNet network, which has the following training processes:
building a training data set, wherein N pieces of optical remote sensing data images are collected, some of the images which meet a terrain specific to aircraft take-off and landing are selected for amplification, interception, and data set labeling, namely labeling the position and the area size of the aircraft taking off and landing runway, wherein all labeled images are used as training samples which then constitute a training data set;
initializing parameters in the PSPNet network;
inputting all the training samples in the training set into the PSPNet network to train the PSPNet network; and
calculating a loss function, calculating a cross entropy between the prediction result obtained after the training samples are input into the PSPNet network and the training sample labels, wherein the calculated cross entropy is between all pixel points in the prediction image that enclose the area of the aircraft take-off and landing runway and all pixel points in the training samples that label the aircraft take-off and landing runway; through repeated iterative training and automatic adjustment of the learning rate, obtaining an optimal network model when the loss function value stops dropping; and
detecting the image to be detected, inputting the image to be detected into the trained PSPNet network for prediction, filling the predicted pixel points in red, and outputting the prediction result, wherein the area surrounded by all pixel points filled in red is the runway area where the aircraft takes off and lands.

2. The method for identification and recognition of the aircraft take-off and landing runway based on the PSPNet network according to claim 1, wherein a residual network ResNet and a lightweight deep neural network MobileNetV2 are adopted for the two backbone feature-extraction networks,
wherein by adopting the residual network ResNet and the lightweight deep neural network MobileNetV2, feature extraction is performed for the input image respectively to obtain two feature maps.

3. The method for identification and recognition of the aircraft take-off and landing runway based on the PSPNet network according to claim 2, wherein the two enhanced feature-extraction modules perform further feature extraction on the two feature maps, specifically including that the feature map obtained by the residual network ResNet are divided into regions sized by 2×2 and 1×1 for processing, and the feature map obtained by the lightweight deep neural network MobileNetV2 are divided into regions sized by 9×9, 6×6, and 3×3 for processing.
